(19) United States
(12) Patent Application Publication
(10) Pub. No.: US 2026/0160853 A1
(43) Pub. Date: Jun. 11, 2026

(54) METHOD AND APPARATUS FOR POSITIONING A TERMINAL DEVICE

(71) Applicant: Nokia Technologies Oy, Espoo (FI)

(72) Inventors: Jun GAO, Shanghai (CN); Chengan ZHANG, Shanghai (CN); Dong HUANG, Shanghai (CN)

(21) Appl. No.: 18/706,924

(22) PCT Filed: Nov. 8, 2021
(86) PCT No.: PCT/CN2021/129339

§ 371 Date: May 2, 2024

(51) Int. Cl. G01S 5/02; G01S 5/04; G01S 7/00; G01S 13/76

(52) U.S. Cl. CPC G01S 5/0263; G01S 5/04; G01S 7/006; G01S 13/765

(57) ABSTRACT

A method for positioning a terminal device using an apparatus is provided. The method comprises: performing a first positioning of the terminal device based on WiFi angle estimation received from the terminal device: rotating a mmW antenna array to a target direction based on the first positioning: transmitting a radar signal via the rotated mmW antenna array; and performing a second positioning of the terminal device based on an echo received from the terminal device.

### TECHNICAL FIELD

The teachings in accordance with example embodiments of present disclosure relate generally to wireless communication and, more specifically, relate to positioning a terminal device.

### BACKGROUND

This section is intended to provide a background or context to example embodiments of the present disclosure. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

GPS and WiFi are considered as typical solution for positioning a terminal device. Due to very poor signal indoor, GPS cannot be efficiently used as indoor positioning solution. While WiFi can provide meter-level range resolution for indoor positioning, which may not meet the requirement for cm-level accuracy.

Certain abbreviations that may be found in the description and/or in the Figures are herewith defined as follows:

| | |
|---|---|
| ADC | Analog to Digital Converter |
| ANT | Antenna |
| AoA | Angle of Arrival |
| BB | baseband |
| BS | Base Station |
| Comm. | Communication |
| CPE | Customer Premise Equipment |
| CRS | Communication and Radar Sharing |
| DAC | Digital to Analog Converter |
| FFT | Fast Fourior Transform |
| FMCW | Frequency Modulated Continuous Wave |
| FR2 | Frequency Range 2 |
| FTTH | Fiber to The Home |
| FWA | Fixed Wireless Access |
| LO | Local Oscillator |
| MCU | Microcontroller Unit |
| mmW | millimetre Wave |
| NR | New Radio |
| PHY | Physical Layer |
| PMCW | Pulse Modulated Continuous Wave |
| RX | Receiver |
| SDR | Software Defined Radio |
| ToA | Time of Arrival |
| TRX | Transceiver |
| TX | Transmitter |
| 3GPP | 3rd Generation Partnership Project |

### SUMMARY

The scope of protection sought for various embodiments of the present disclosure is set out by the independent claims. The embodiments and features, if any, described in this specification that do not fall under the scope of the independent claims are to be interpreted as examples useful for understanding various embodiments of the present disclosure.

According to a first aspect, various embodiments provide a method for positioning a terminal device using an apparatus. The method comprises: performing a first positioning of the terminal device based on WiFi angle estimation received from the terminal device; rotating a mmW antenna array to a target direction based on the first positioning; transmitting a radar signal via the rotated mmW antenna array; and performing a second positioning of the terminal device based on an echo received from the terminal device.

According to a second aspect, various embodiments provide an apparatus. The apparatus comprises at least one processor and at least one memory including computer program code. The at least one memory and the computer program code configured to, with the at least one processor, cause the apparatus to perform a first positioning of the terminal device based on WiFi angle estimation received from the terminal device, rotate a mmW antenna array to a target direction based on the first positioning, transmit a radar signal via the rotated mmW antenna array, and perform a second positioning of the terminal device based on an echo received from the terminal device.

According to a third aspect, various embodiments provide a non-transitory computer readable storage medium. The non-transitory computer readable storage medium comprises computer program code that, when executed by one or more processors of an electronic device, cause the electronic device to perform a first positioning of the terminal device based on WiFi angle estimation received from the terminal device, rotate a mmW antenna array to a target direction based on the first positioning, transmit a radar signal via the rotated mmW antenna array, and perform a second positioning of the terminal device based on an echo received from the terminal device.

According to some embodiments, the second positioning comprises mmW angle estimation and mmW range estimation.

According to some embodiments, the electronic device can further upload the positioning data of the second positioning to a data center.

According to some embodiments, the second positioning is activated by independent receive paths.

According to some embodiments, the electronic device can further rotate the mmW antenna array to the direction of the mmW base station when the electronic device is switched to mmW communication mode; and the electronic device can further translate the received communication signal between the WiFi communication signal and the mmW communication signal.

In some examples of embodiments, the radar signal is coded with a first waveform code design before transmitting in mmW radar mode, while the translated communication signal is coded with the first waveform code design before transmitting in mmW communication mode.

In some examples of embodiments, the received echo is decoded with a second waveform code design in mmW radar mode, while the responding communication signal is decoded with the second waveform code design in mmW communication mode.

According to some embodiments, the electronic device can further determine whether the apparatus is in mmW radar mode or in mmW communication mode; and in response to determining that the apparatus is in mmW radar mode, perform the first positioning for the terminal device.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of embodiments of the disclosure and are not necessarily drawn to scale, in which:

FIG. 1 illustrates an example of CPEs in FWA end to end scenarios comprising various terminal devices used in carrying out some example embodiments of the present disclosure;

FIG. 2 illustrates an example of demonstration of relationship between indoor positioning accuracy and large-scale difficulty;

FIG. 3 illustrates an example of how AoA is calculated in practicing some example embodiments of this present disclosure;

FIG. 4 illustrates an example of mmW CPE in Communication Mode according to some example embodiments of the present disclosure;

FIG. 5 illustrates an example of mmW CPE in Radar Mode according to some example embodiments of the present disclosure;

FIG. 6 illustrates a flow chart of examples of method for positioning a terminal device by mmW CPE according to some example embodiments of the present disclosure;

FIG. 7 illustrates an example of WiFi front end for AoA according to some example embodiments of the present disclosure;

FIG. 8 illustrates an example of beacon-controlled mmW antenna array according to some example embodiments of the present disclosure;

FIG. 9 illustrates an example of CRS-supported mmW CPE architecture according to some example embodiments of the present disclosure;

FIG. 10a illustrates an example of range estimation scenarios of ToA method according to some example embodiments of the present disclosure; and FIG. 10b illustrates parameter relationship of ToA method according to some example embodiments of the present disclosure.

### DETAILED DESCRIPTION OF EXAMPLE EMBODIMENTS

Principle of the present disclosure will now be described with reference to some example embodiments. It is to be understood that these example embodiments are described only for the purpose of illustration and for helping those skilled in the art to understand and implement the present disclosure, without suggesting any limitation as to the scope of the disclosure. The embodiments described herein can be implemented in various manners which are not limited to the ones described below.

In the following description and claims, unless defined otherwise, all technical and scientific terms used herein have the same meaning as commonly understood by one of ordinary skills in the art to which this disclosure belongs.

As used herein, the term “terminal device” refers to any terminal device capable of wireless communications with another terminal device or with CPE. The communications may involve transmitting and/or receiving wireless signals using WiFi signals, mmW radar signals, and/or other types of signals suitable for conveying information over air.

Examples of the terminal device include, but are not limited to, user equipment (UE) such as smart phones, wireless-enabled tablet computers, laptop-embedded equipment (LEE), laptop-mounted equipment (LME), sensors, metering devices, personal wearables such as watches etc., and/or vehicles that are capable of communication.

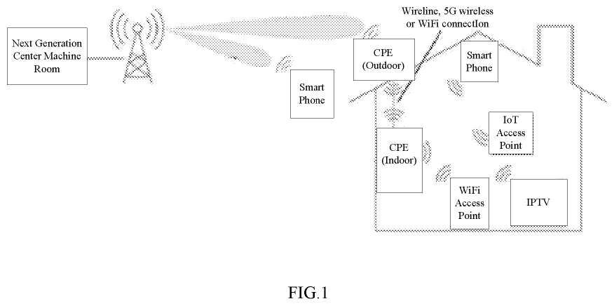

Before describing the example embodiments of the present disclosure in detail, reference is made to FIG. 1 for illustrating FWA end to end scenarios where CPEs are deployed.

CPE is used for home broadband, especially in the situations that FTTH cannot be installed. As Shannon Theorem said, C=W*log 2 (1+S/N). Since mmW has fluent spectrum resources, the throughput can reach 10 Gbps. MmW CPE can be carefully used in FWA scenarios both indoor and outdoor due to mmW's serious channel attenuation, as FIG. 1 shows.

For indoor positioning, mmW CPE may connect to several terminal devices such as smart phone, IPTV, and perform a cm-level range position of these terminal devices. The scenario of outdoor positioning is similar. The mmW CPE may connect to one or more terminal devices and provide a cm-level range position of these terminal devices. In some embodiments, the outdoor CPE can serve as a relay for the indoor CPE to/from the Next Generation Center Machine Room, and the two CPEs can connected through wireline, 5G wireless or WiFi connection.

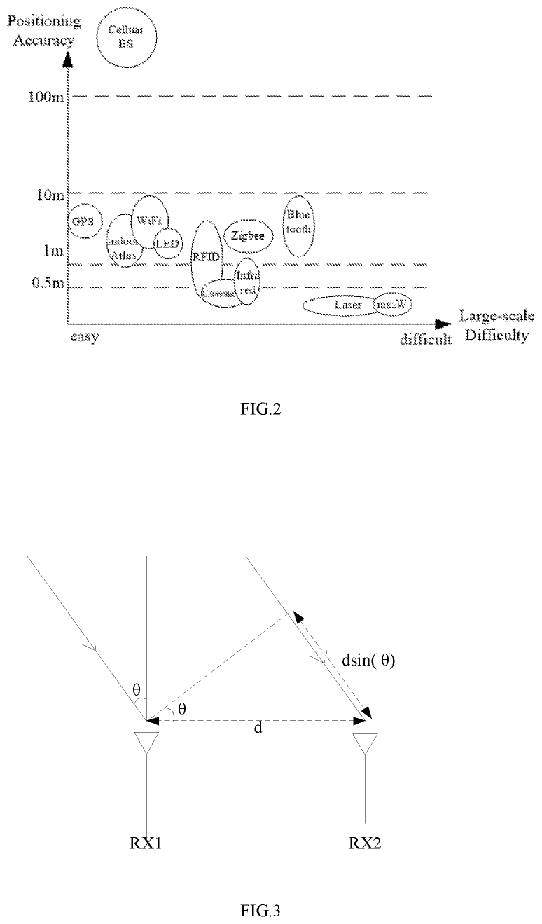

As FIG. 2 shows, there are various indoor positioning solutions available. FIG. 2 shows the relationship between positioning accuracy and large-scale difficulty. WiFi, Indoor Atlas, LED, Zigbee, Bluetooth can provide meter-level range resolution for indoor positioning. For submeter-level accuracy, RFID, Ultrasonic and Infrared can do the work. When it comes to a more accurate requirement such as cm-level resolution, typically laser and mmW can achieve the goal.

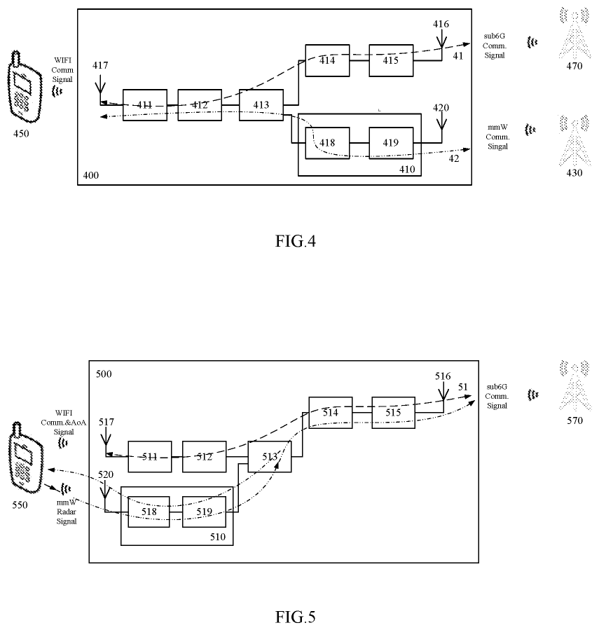

FIG. 3 illustrates how AoA is calculated in practicing some example embodiments of this present disclosure.

FIG. 3 gives the typical AoA theorem. As FIG. 3 shows,

$$∵ \frac{d sin ( θ )}{λ} = \frac{ω}{2 π} \qquad ( 1 )$$

$$∴ θ = {sin}^{- 1} ( \frac{λω}{2 π d} ) \qquad ( 2 )$$

### Here,

d is the distance between two receive antenna,
θ is the angle of arrival of an object comparing with the boresight of the antenna,
λ is the wavelength at special working frequency,
ω is the phase change due to the distance change of the object to the radar receiver.

Let us take FMCW radar as an example. For FMCW Radar, there is the range resolution formula as following,

$${d}_{r e s} = \frac{C}{2 B} \qquad ( 3 )$$

### Here,

dᵣₑₛ is the range resolution,
C is the spread speed of the electromagnetic wave in free space,
B is the bandwidth of frequency sweeping.

In order to get cm-level range resolution, the bandwidth B should be in the GHz level, which means mmW frequency band spectrum could be used.

As discussed above, lidar and mmW radar can provide cm-Level accuracy. But lidar is too expensive and is typically not suitable for use in smoke & fog environment. While 24 GHz mmW radar (24-24.25 GHz) may have serious coexistence issue with 3GPP NR FR2 n258 (24.25-27.5 GHz).

70 GHz radar can be chosen to avoid coexistence issue with n258, but there is high power consumption and high cost when separate mmW radar module and mmW communication module are applied.

The embodiments of the present disclosure provide a mmW CPE supporting Communication and Radar Sharing solution. Based on the scheduling of mmW communication mode or mmW radar mode, the CPE can work on coding either the communication bit-sequence or the radar signal. Therefore, the CRS-supported CPE in the embodiments of the present disclosure can offer the following benefits:
a) sharing the common coding waveform design for unified-scheduling of mmW communication mode and mmW radar mode, in order to avoid coexistence issue;
b) sharing the same front-end hardware to make size compact and power consumption low;
c) using WiFi AoA for rough positioning to automatically adjust motor to rotate mmW antenna array for radar mode.

Further, the CRS-supported CPE in the embodiments of the present disclosure is the SDR solution, not only in hardware side, but also in baseband (Physical Layer) process side. In some embodiments, the CRS module comprises a mmW TRX and a mmW BB.

Now reference is made to FIG. 4 which shows examples of mmW CPE in Communication Mode according to some example embodiments of the present disclosure.

As FIG. 4 shows, when mmW CPE 400 is in the communication mode, there are two communication links 41, 42. The communication link 41 is between terminal device 450 and sub6G BS 470. And the communication link 42 is between terminal device 450 and mmW BS 430. WiFi TRX 411 receives WiFi communication signal from terminal device 450 via WiFi ANT Array 417, WiFi modem 412 processes the received WiFi communication signal and MCU 413 routes the processed WiFi communication signal to its destination. On the communication link 41, sub6G BB 414 translates the WiFi communication signal to sub6G communication signal, then sub6G TRX 415 transmits the sub6G communication signal to sub6G BS 470 via sub6G ANT Array 416. On the communication link 42, CRS module 410 comprises mmW BB 418 and mmW TRX 419. The mmW BB 418 translates the WiFi communication signal to mmW communication signal, then mmW TRX 419 transmits the mmW communication signal to mmW BS 430 via mmW ANT Array 420 and vice versa. As for communication from the sub6G BS 470 to the terminal device 450, sub6G TRX 415 can receive the sub6G communication signal via sub6G ANT Array 416, and sub6G BB 414 can translate the sub6G communication signal to WiFi communication signal, then the WiFi communication signal can be delivered to the terminal device 450 through MCU 413, WiFi modem 412, WiFi TRX 411 and WiFi ANT Array 417. As for communication from the mmW BS 430 to the terminal device 450, mmW TRX 419 can receive the mmW communication signal from the mmW BS 430 via mmW ANT Array 420, and mmW BB 418 can translate the mmW communication signal to WiFi communication signal, then the WiFi communication signal can be delivered to the terminal device 450 through MCU 413, WiFi modem 412, WiFi TRX 411 and WiFi ANT Array 417. The communication between the terminal device 450 and the sub6G BS 470 on the communication link 41 is not relevant to the present disclosure and thus not discussed in the present disclosure.

When the mmW CPE 400 is in Communication Mode between mmW BS 430 and terminal device 450, the CRS module 410 functions as the communication module to: 1) from the mmW BS side, receive mmW communication signal and translate the received mmW communication signal to WiFi communication signal to the terminal device; and 2) from the terminal device, receive WiFi communication signal and translate the received WiFi communication signal to mmW communication signal to the mmW BS.

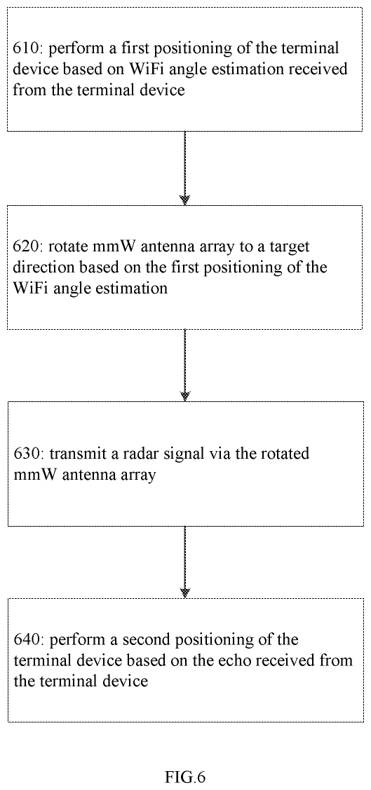

Referring to FIG. 5, it shows examples of mmW CPE in Radar Mode according to some example embodiments of the present disclosure. FIG. 6 shows a flow chart of examples of method for positioning a terminal device by mmW CPE according to some example embodiments of the present disclosure.

As FIG. 5 shows, when the mmW CPE 500 is in Radar Mode for positioning the terminal device 550, the CRS module 510 functions as the radar module to: transmit mmW radar signal to the terminal device 550 and receive the echo from the terminal device 550; position the terminal device 550 by mmW AoA and mmW ToA based on the echo. The CRS module performs a more accurate positioning for the terminal device 550 on cm-level, comparing the rough positioning by WiFi AoA.

Further, CRS module 510 comprises mmW BB 518 and mmW TRX 519. The mmW BB 518 can report the positioning result of the terminal device 550 to a data center through the sub6G BS 570. Please note that, the “data center” refers to any database capable of storing the terminal device's position data, which includes, but not limited to database for specific/general purpose, cloud storage, and/or other types of storage suitable for storing information. The position data can be used for data collecting, data analyses for specific application purpose. The further usage of terminal device's position data is not limited in the present disclosure, nor discussed.

There is also a communication link 51 between the terminal device 550 and the sub6G BS 570. For the communication from the sub6G BS 570 to the terminal device 550, sub6G TRX 515 can receive the sub6G communication signal via sub6G ANT Array 516, and sub6G BB 514 can translate the sub6G communication signal to WiFi communication signal, then the WiFi communication signal can be delivered to the terminal device 550 through MCU 513, WiFi modem 512, WiFi TRX 511 and WiFi ANT Array 517. For the communication from terminal device 550 to the the sub6G BS 570, WiFi TRX 511 can receive the WiFi communication signal via WiFi ANT Array 517, WiFi modem 512 can process the received WiFi communication signal and MCU 513 can route the processed WiFi communication signal to sub6G BB 514, and sub6G BB 514 can translate the WiFi communication signal to sub6G communication signal, then the WiFi communication signal can be delivered to sub6G BS 570 via sub6G ANT Array 516 by sub6G TRX 515. Therefore, after translation from the terminal device's WiFi communication signal, basic communication data can be uploaded to sub6G BS 570. And basic communication data can be downloaded from sub6G BS 570 and translated as WiFi communication signal to the terminal device 550.

Referring to FIG. 5 and FIG. 6, in radar mode, at step 610, WiFi modem 512 performs a first positioning of the terminal device 550 based on WiFi angle estimation received from the terminal device 550.

In some embodiments, mmW CPE determines whether itself is in Radar Mode or Communication Mode. When the mmW CPE is determined in Radar Mode, the first positioning of the terminal device 550 at step 601 is triggered, or else mmW CPW is in Communication Mode.

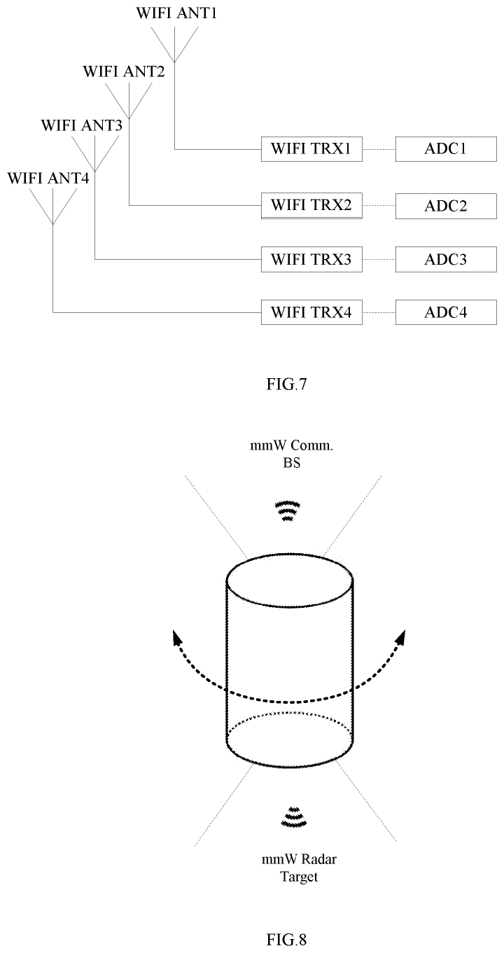

FIG. 7 shows an example of WiFi front end for AoA according to some example embodiments of the present disclosure. According to Formula (1),

$$w = \frac{2 π d sin ( θ )}{λ} \qquad ( 4 )$$

### Basically, |ω|<180°, so

$$θ < {sin}^{- 1} ( \frac{λ}{2 d} ) \qquad ( 5 )$$

When d=λ/2,

$${θ}_{max} = \pm 90 ° \qquad ( 6 )$$

Then WiFi ANT 1&2 composes Array1, and WiFi ANT 3&4 composes Array2, thus 360° angle positioning can be reached.

As discussed above, WiFi can provide a meter-level accuracy for positioning a terminal device. WiFi communication signal can be reached to WiFi modem 512 to decide the rough angle θ of the target (i.e., the terminal device 550) according to Formula (1) and (2). WiFi AoA can provide a rough positioning for terminal device 550.

Referring back to FIG. 6, at step 620, mmW CPE rotates mmW antenna array to a target direction based on the first positioning of the WiFi angle estimation.

For cm-level range resolution, it requires directing the mmW antenna array towards the target direction which can be determined by the WiFi AoA rough positioning.

In order to share front end, mmW CPE rotates the mmW antenna array 520 between the mmW BS direction and the terminal device direction to switch in the communication mode and radar mode. When in the mmW radar mode, mmW CPE rotates the mmW antenna array 520 to the target direction which covers the target terminal device as WiFi angle estimation can give a rough angle range of the target terminal device.

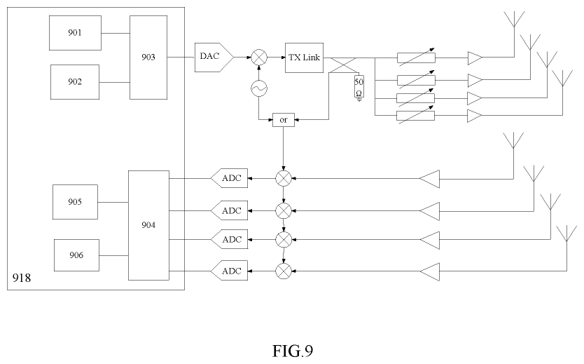

FIG. 8 shows an example of beacon-controlled mmW antenna array according to some example embodiments of the present disclosure. As FIG. 8 shows, WiFi AoA rough positioning can control mmW antenna array beacon to the target by motor rotation, since mmW antenna array has narrow beam coverage, such as about 120° angle, which depends on detailed mmw antenna array design.

Referring back to FIG. 5 and FIG. 6, at step 630, mmW TRX 519 transmits a radar signal via the rotated mmW antenna array 520. At step 640, mmW BB 518 performs a second positioning of the terminal device 550 based on the echo received from the terminal device 550.

After the mmW antenna array 520 is rotated to the target direction in step 620, mmW TRX 519 can transmit a radar signal such as FMCW or PMCW signal, via the rotated mmW antenna array 520 in the antenna coverage. Then, at step 640, after receiving the echo from the terminal device 550, mmW BB 518 can perform a second positioning of the terminal device 550.

FIG. 9 shows an example of CRS-supported mmW CPE architecture according to some example embodiments of the present disclosure.

As FIG. 9 shows, in mmW BB 918, there are 2 kinds of waveform generators for digital radar waveform and modulated communication bit-sequence, respectively. In radar mode, the digital radar waveform generated by Digital Radar Waveform Generator 901 is coded in Common Coding 903, while in communication mode, the modulated communication bit-sequence generated by Modulated Communication Bit-sequence Generator 902 is coded in Common Coding 903. That is, Common Coding 903 can be used for a same waveform coding design for both communication mode and radar mode, respectively. The CRS scheduling, i.e., selection of communication mode or radar mode, can be determined in various ways such as by manual adjustment, by customer self-adaption or by machine learning, depending on the specific implementation or settings. After coding, the coded signal, i.e., the coded digital radar waveform in radar mode or the coded communication bit-sequence in communication mode, can be sent to DAC. Then the signal can be mixed by mmW local oscillator, finally analogue-beamformed to get narrower beam for wider coverage. This coverage is for both communication mode and radar mode.

In some examples of embodiments, the radar signal is coded with a first waveform code design in Common Coding 901 before transmitting in mmW radar mode, while the translated communication signal is coded with the same first waveform code design in Common Coding 901 before transmitting in mmW communication mode.

In some examples of embodiments, the received echo is decoded with a second waveform code design in Common Decoding 904 in mmW radar mode, while the responding communication signal is decoded with the same second waveform code design in Common Decoding 904 in mmW communication mode.

In some examples of embodiments, the first waveform code design and the second waveform code design can be the same.

At the receiving part, each receive path can be independently down converted and independently converted to digital signal.

For radar function, mmW AoA can be activated by independent RX paths. Then LO can use TX-coupled signal for FMCW/PMCW similar range estimation. After ADC, Common Decoding 904 can decode the received signal, and Radar Parameter Estimation 905 can do angle estimation and range estimation based on the decoded signal. Communication symbols can be removed before estimation.

For communication function, independent RX paths can be used as digital beamforming. Then LO can use the same frequency source with TX for FDD/TDD communication usage. After ADC, the received signal can be decoded in the Common Decoding 904 and demodulated in the Demodulation 906, and then related communication BB processes can be done.

Referring to FIG. 6 and FIG. 9, at the transmitting stage, mmW BB 518 can code the digital radar waveform, and mmW TRX 519 can then transmit the coded radar signal.

At the receiving stage, the mmW BB 518 can make angle estimation and range estimation in mmW radar mode.

Formula (2) may also be applicable for mmW angle estimation. The following Formula (7) is used for angle resolution:

$${θ}_{res} = \frac{λ}{N d cos ( θ )} \qquad ( 7 )$$

Different from WiFi AoA (WiFi AoA antenna array 1 and array 2 both have 2 paths), where N=2; in mmW angle estimation N can be equal to 4. According to Formula (7), better angle resolution can be reached.

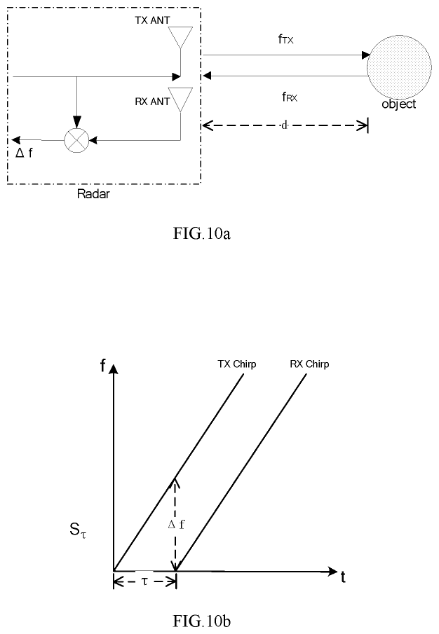

FIG. 10a shows an example of range estimation scenarios of ToA method according to some example embodiments of the present disclosure. FIG. 10b shows parameter relationship of ToA method according to some example embodiments of the present disclosure. Take linear FMCW radar as an example. TX transmits TX Chirp while RX receives echo of RX Chirp with the delay T, as FIGS. 10a and 10b show.

### Since

$$\{ \begin{matrix}Δ f = {f}_{Tx} - {f}_{Rx} & ( 8 ) \\ {s}_{τ} = \frac{Δ f}{τ} & ( 9 ) \\ d = 2 C \cdot τ & ( 10 )\end{matrix}$$

The following formula can be obtained:

$$d = 2 C \cdot \frac{Δ f}{{s}_{τ}} \qquad ( 11 )$$

### Here,

f_{Tx} is TX frequency of TX chirp with the linear frequency modulated continuous wave,
f_{Rx} is RX frequency of RX chirp of echo when object (i.e., terminal device) is reached,
d is the distance between Radar and object,
Δf is the difference frequency (intermediate frequency) between f_{Tx} and f_{Rx},
τ is the delay between transmitted signal and the echo,
s_{τ} is the slope of frequency vs time.

After mixing, intermediate frequency (Δf) can be produced. Then after ADC and digital signal process in Radar Parameter Estimation 907, Δ f information can be obtained. The algorithms of digital signal process may include FFT, Peak Spectrum Detection, Spectrum Matching, etc.

According to Formula (11), range parameter d can be calculated.

In some embodiments, when mmW CPE switches from Radar Mode to Communication Mode, for example, mmW CPE completes the positioning of the terminal device, referring back to FIG. 4, the mmW ANT Array 420 is rotated to the mmW BS 430 to facilitate the communication between the terminal device 450 and the mmW BS 430.

According to some embodiments of the present disclosure, a non-transitory computer readable storage medium is provided. The non-transitory computer readable storage medium comprises computer program code that, when executed by one or more processors of an electronic device, cause the electronic device to perform the following operations:
performing a first positioning of the terminal device based on WiFi angle estimation received from the terminal device;
rotating a mmW antenna array to a target direction based on the first positioning; transmitting a radar signal via the rotated mmW antenna array; and
performing a second positioning of the terminal device based on an echo received from the terminal device.

In some embodiments, the second positioning comprises mmW angle estimation and mmW range estimation.

In some embodiments, the electronic device can further upload the positioning data of the second positioning to a data center.

In some embodiments, the second positioning is activated by independent receive paths.

In some embodiments, the electronic device can further rotate the mmW antenna array to the direction of the mmW base station when the electronic device is switched to mmW communication mode; and the electronic device can further translate the received communication signal between the WiFi communication signal and the mmW communication signal.

In some examples of embodiments, the radar signal is coded with a first waveform code design before transmitting in mmW radar mode, while the translated communication signal is coded with the first waveform code design before transmitting in mmW communication mode.

In some examples of embodiments, the received echo is decoded with a second waveform code design in mmW radar mode, while the responding communication signal is decoded with the second waveform code design in mmW communication mode.

In some examples of embodiments, the first waveform code design and the second waveform code design can be the same.

In some embodiments, the electronic device can further determine whether the apparatus is in mmW radar mode or in mmW communication mode; and in response to determining that the apparatus is in mmW radar mode, perform the first positioning for the terminal device.

In general, various embodiments may be implemented in hardware or special purpose circuitry, software, logic or any combination thereof. For example, some aspects may be implemented in hardware, while other aspects may be implemented in firmware or software which may be executed by a controller, microprocessor or other computing device, although the present disclosure is not limited thereto. While various aspects of the present disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example, embodiments of the present disclosures may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used in this disclosure, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The word “example” is used herein to mean “serving as an example, instance, or illustration.” Any embodiment described herein as “example” is not necessarily to be construed as preferred or advantageous over other embodiments. All of the embodiments described in this Detailed Description are example embodiments provided to enable persons skilled in the art to make or use the present disclosure and not to limit the scope of the present disclosure which is defined by the claims.

The foregoing description has provided by way of example and non-limiting examples a full and informative description of the best method and apparatus presently contemplated by the inventors for carrying out the present disclosure. However, various modifications and adaptations may become apparent to those skilled in the relevant arts in view of the foregoing description, when read in conjunction with the accompanying drawings and the appended claims. However, all such and similar modifications of the teachings of this present disclosure will still fall within the scope of this present disclosure.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of some example embodiments of this present disclosure could be used to advantage without the corresponding use of other features. As such, the foregoing description should be considered as merely illustrative of the principles of the present disclosure, and not in limitation thereof.

1. A method for positioning a terminal device using an apparatus, the method comprising:
performing a first positioning of the terminal device based on WiFi angle estimation received from the terminal device;
rotating a mmW antenna array to a target direction based on the first positioning;
transmitting a radar signal via the rotated mmW antenna array; and
performing a second positioning of the terminal device based on an echo received from the terminal device.

2. The method of claim 1, wherein the second positioning comprises mmW angle estimation and mmW range estimation.

3. The method of claim 1, wherein the method further comprises:
uploading the positioning data of the second positioning to a data center.

4. The method of claim 1, wherein the second positioning is activated by independent receive paths.

5. The method of claim 1, wherein the method further comprises:
rotating the mmW antenna array to the direction of the mmW base station in response to the apparatus being switched to mmW communication mode; and
translating the received communication signal between the WiFi communication signal and the mmW communication signal.

6. The method of claim 5, wherein the radar signal is coded with a first waveform code design before transmitting in mmW radar mode, while the translated communication signal is coded with the first waveform code design before transmitting in mmW communication mode.

7. The method of claim 6, wherein the received echo is decoded with a second waveform code design in mmW radar mode, while the responding communication signal is decoded with the second waveform code design in mmW communication mode.

8. The method of claim 1, wherein the method further comprises:
determining whether the apparatus is in mmW radar mode or in mmW communication mode; and
in response to determining that the apparatus is in mmW radar mode, perform the first positioning for the terminal device.

9. An apparatus comprising:
at least one processor;
at least one memory including computer program code;
the at least one memory and the computer program code configured to, with the at least one processor, cause the apparatus to perform operations including:
performing a first positioning of the terminal device based on WiFi angle estimation received from the terminal device;
rotating a mmW antenna array to a target direction based on the first positioning;
transmitting a radar signal via the rotated mmW antenna array; and
performing a second positioning of the terminal device based on an echo received from the terminal device.

10. The apparatus of claim 9, wherein the second positioning comprises mmW angle estimation and mmW range estimation.

11. The apparatus of claim 9, wherein the apparatus further performs:
uploading the positioning data of the second positioning to a data center.

12. The apparatus of claim 9, wherein the second positioning is activated by independent receive paths.

13. The apparatus of claim 9, wherein the apparatus further performs:
rotating the mmW antenna array to the direction of the mmW base station in response to the apparatus being switched to mmW communication mode; and
translating the received communication signal between the WiFi communication signal and the mmW communication signal.

14. The apparatus of claim 13, wherein the radar signal is coded with a first waveform code design before transmitting in mmW radar mode, while the translated communication signal is coded with the first waveform code design before transmitting in mmW communication mode.

15. The apparatus of claim 14, wherein the received echo is decoded with a second waveform code design in mmW radar mode, while the responding communication signal is decoded with the second waveform code design in mmW communication mode.

16. The apparatus of claim 9, wherein the apparatus further performs:
determining whether the apparatus is in mmW radar mode or in mmW communication mode; and
in response to determining that the apparatus is in mmW radar mode, performing the first positioning for the terminal device.

17. A non-transitory computer readable storage medium comprising computer program code that, when executed by one or more processors of an electronic device, cause the electronic device to perform operations comprising:
performing a first positioning of the terminal device based on WiFi angle estimation received from the terminal device;
rotating a mmW antenna array to a target direction based on the first positioning;
transmitting a radar signal via the rotated mmW antenna array; and
performing a second positioning of the terminal device based on an echo received from the terminal device.
